(19) United States
(12) Patent Application Publication
(10) Pub. No.: US 2016/0273729 A1
(43) Pub. Date: Sep. 22, 2016

(54) ILLUMINATING AND/OR SIGNALING MODULE FOR AN AUTOMOTIVE VEHICLE

(71) Applicant: Valeo Vision, Bobigny Cedex (FR)

(72) Inventors: Pierre ALBOU, Paris (FR); Michel HERMITTE, Angers (FR)

(21) Appl. No.: 14/778,438

(22) PCT Filed: Mar. 20, 2014
(86) PCT No.: PCT/EP2014/055638

§ 371 Date: Sep. 18, 2015

(30) Foreign Application Priority Data
Mar. 21, 2013 (FR) 1352512

(51) Int. Cl. F21S 8/10; B60Q 1/34

(52) U.S. Cl. CPC F21S 48/137; F21S 48/234; F21S 48/125; F21S 48/115; F21S 48/215; B60Q 1/34; F21S 48/1275

(57) ABSTRACT

A lighting and/or signaling module for an automobile vehicle, the module comprising a light source e, a reflecting surface and a toroidal lens. The reflecting surface is calculated in such a manner that the rays coming from the module, reflected then transmitted by the lens, are perpendicular to and encounter a circular arc A. This geometry of the outgoing rays endows them with a toroidal wavefront which allows the principle of constancy and of reversibility of the light path (Fermat's principle) to be applied and, consequently, a straightforward calculation of the reflecting surface. The beam thus produced can notably provide a daytime running light or, alternatively, a direction indicator function. The module may comprise another lighting function of the high-beam type using another portion of the lens.

### CROSS-REFERENCE TO RELATED APPLICATIONS

This application is the U.S. National Phase application of PCT Application No. PCT/EP2014/055638 filed Mar. 20, 2014, which claims priority to the French application 1352512 filed on Mar. 21, 2013, which applications are incorporated herein by reference and made a part hereof.

### BACKGROUND OF THE INVENTION

1. Field of the Invention

The invention relates to a lighting and/or signaling module for an automobile vehicle. The invention also relates to an automobile vehicle headlamp comprising the module. The invention also relates to a method for fabrication of the module.

2.Description of the Related Art

The presence of a DRL (acronym for Daytime Running Light) function is now common in the headlamps of automobile vehicles, notably owing to it being obligatory in a large number of countries. This DRL function requires a diffuse illumination at the front of the vehicle which ensures a better visibility of the latter under daytime conditions. This DRL function is subject to regulation, for example for the European countries by the regulation n°87 of the United Nations Economic Commission for Europe (UNECE) entitled “UNIFORM PROVISIONS CONCERNING THE APPROVAL OF DAYTIME RUNNING LAMPS FOR POWER-DRIVEN VEHICLES”. One example of distribution of light beams conforming to this regulation is presented in FIGS. 11 and 12 of the patent document EP 2444284 in the name of the applicant.

The integration of this function into a headlamp does however present certain difficulties, notably with regard to the cost of manufacture and to the style of the headlamp.

The patent document EP 2 143 994 A1 discloses a headlamp comprising one or more lighting modules with horizontal beam limit providing a lighting function of the low-beam type, and a lighting module of the high-beam type. The high-beam module comprises a light source illuminating within a half-space and a reflector of the parabolic type. The module is characterized in that it comprises a transparent cover mobile between an inactive position and an active position where it is traversed by the rays from the light source directed toward the reflecting surface of the reflector. The transparent cover comprises a diffuser lens. When the daytime running light DRL function is activated, the electrical power supplying the light source is reduced and, in parallel, the cover is disposed in its active position. This solution has advantages from the point of view of simplicity of implementation. It is however essentially limited to a lighting module with a geometric reflecting surface and with a circular lens. The function of the cover consisting in diffusing the light coming from the light source is indeed not easily applicable to a module with a complex reflecting surface. Moreover, the mobile installation of the cover and its motorization can constitute causes of failure.

The patent document EP 2 187 115 A2 discloses a dual-function lighting and signaling module, with a first lighting function of the low-beam type conventionally comprising a first light source, a reflector of the elliptical type and a circular lens of the plano-convex type and means for cutting-off the beam. The second function is a function of the daytime running light DRL type. It comprises a second light source and potentially a second reflecting surface, disposed under the elements corresponding to the first function. It uses an extension of the lens of the low-beam lighting function, the extension comprising lenticular surfaces designed to provide a suitable light beam. The lens of the module thus has a very particular shape which limits the solution provided by this teaching to a very specific style of headlamp.

The patent document FR 2 960 497 A1, which is equivalent to U.S. Patent Publication 2011/0292669, which is issued as U.S. Pat. No. 8,651,716, describes a dual-function lighting module for an automobile vehicle headlamp, essentially comprising a light source, a reflecting surface and a lens. The module is characterized in that the lens runs parallel to a control curve, the lens having a cross-section transverse to the curve which is essentially constant. The lens thus has a generally toroidal shape. The reflecting surface is calculated following the reverse path of the light and on the basis of a constancy of the path of the light conforming to Fermat's principle. More particularly, the module described in this teaching is a dual-function module with a first lighting function with a horizontal cut-off, such as a fog lighting function or a low-beam headlamp function. The horizontal distribution of this first function is controlled by the plane control curve used in the calculation of the corresponding reflecting surface. The dual-function module also comprises a second lighting function designed to complete the first in order to provide a lighting function of the high-beam type. The corresponding reflecting surface is calculated by considering that the rays exiting from the lens are all parallel to a chosen direction of illumination. The reflecting surfaces of the two functions use the same lens. This teaching does not however provide any other signaling function, notably of the daytime running light DRL or direction indicator type.

The patent document EP 1 610 057 A1, which is equivalent to U.S. Patent Publication 2006/0002130, which issued as U.S. Pat. No. 7,682,057, discloses a lighting module producing an illuminating beam with cut-off, of the low-beam headlamp or fog lamp type. This module essentially comprises a light source, a reflector associated with a plane plate generating the cut-off and a lens of the toroidal type. The reflector is determined for transforming a spherical wave surface coming from the source into a wave surface concentrated into a circular arc situated in the plane of the plate, and in that the lens has a shape of revolution about an axis substantially orthogonal to the plane of the plate and passing through the center of the circular arc. Furthermore, the reflector is such that light rays coming from the source and falling on points situated on a curve formed by the intersection of the surface of the reflector and a vertical plane

passing through the center of the circular arc, but separated from the source, are reflected by the surface of the reflector in this vertical plane in such a manner as to converge onto a point formed by the intersection of the vertical plane and of the circular arc. The rays coming from the module are parallel in vertical planes and do not converge onto the circular arc.

### SUMMARY OF THE INVENTION

The aim of the invention is to provide a lighting and/or signaling module overcoming at least one of the aforementioned drawbacks. More particularly, the aim of the invention is to provide a lighting module comprising a lens of style such as a lens of generally toroidal shape and capable of providing a daytime running light function or a direction indicator function and able to be preferably integrated with a lighting function without cut-off of the high-beam headlamp type.

One subject of the invention is a lighting and/or signaling module, notably for an automobile vehicle, comprising: a light source; a reflector with a reflecting surface configured for reflecting the light rays emitted by the light source; a lens running parallel to a plane control curve G, with a cross-sectional shape at least essentially constant in any cross-section made by a plane perpendicular to G and corresponding to that of a stigmatic reference lens between a point situated behind the lens on the control curve G and infinity in front of the lens, the lens being configured so as to transmit the light rays reflected by the reflector in such a manner as to form a light beam for lighting and/or for signaling; noteworthy in that the reflecting surface of the reflector is configured in such a manner that the rays of the light beams produced by the module, in the case where the light source placed at the focal point of the system is a point source, are perpendicular to a circular arc A situated in a plane parallel to that of the control curve G, and such that the rays or their projections intercept the circular arc.

The module according to the invention does not comprise cut-off means for the light beams, its final purpose being to generate types of beams for signaling or for lighting without cut-offs, in particular a daytime running light beam, a direction indicator beam or else an illuminating beam of the high-beam type.

The module according to the invention advantageously allows headlamps to be provided comprising associations of two modules, or more, these modules having a similar esthetic aspect and comprising a toroidal lens. Amongst the possible associations, the following are notably retained: an association of a first module providing a low-beam headlamp function, for example implemented according to the teaching of the patent document EP 1610057, which is equivalent to U.S. Patent Publication 2006/0002130, which issued as U.S. Pat. No. 7,682,057, or EP 2565533, which is equivalent to U.S. Patent Publication 2012/0306366, with a second module combining the lighting function of the high-beam type and daytime running light or direction indicator function implemented according to the present invention, or else an association of a first dual-function low-beam/high-beam lighting module, for example implemented according to the teaching of the document FR 2960497, which is equivalent to U.S. Patent Publication 2011/0292669, which is issued as U.S. Pat. No. 8,651,716, with a second dual-function signaling module, DRL/direction indicator implemented according to the present invention.

According to one advantageous embodiment of the invention, the reverse optical path of the rays from the circular arc A up to the light source is constant according to the Fermat's principle of reversibility of the light path and of invariance of the optical path followed by the light along a physical path.

According to another advantageous embodiment of the invention, the circular arc A is situated with respect to the lens on the same side as the control curve G, the projection of the rays exiting from the lens intercepting the curve A in planes perpendicular to the curve, in such a manner as to form a divergent beam.

According to yet another advantageous embodiment of the invention, the circular arc A is situated with respect to the lens on the opposite side to that of the control curve G, the rays exiting from the lens intercepting the curve A in a convergent manner in planes perpendicular to the curve.

According to yet another advantageous embodiment of the invention, the reference lens is of the plano-convex type, the lens of the module having a convex exit face.

According to yet another advantageous embodiment of the invention, the lens comprises an exit face running along a plane curve C parallel to the control curve G.

According to yet another advantageous embodiment of the invention, the light source is a first light source and the reflecting surface is a first reflecting surface, the module comprising a second light source and a second reflecting surface configured for reflecting the light rays emitted by the second light source, disposed laterally to the first light source and to the first reflecting surface with respect to the main direction of illumination, the lens running in front of and cooperating with the second light source and the second reflecting surface.

According to yet another advantageous embodiment of the invention, the second reflecting surface is configured in such a manner that the rays of the lighting or signaling beam coming from the second reflecting surface are parallel to a given direction corresponding to a main direction of illumination of the module.

According to yet another advantageous embodiment of the invention, the lens comprises a first part cooperating at least for the most part with the rays coming from the first light source and reflected by the first reflecting surface, the control curve G of the first part being a first control curve, and a second part cooperating at least for the most part with the rays coming from the second light source and reflected by the second reflecting surface, the second part running according to a second plane control curve g, the second control curve g having at least one point in common with the first control curve G, the tangents to the first and second control curves G and g being coincident at the point.

According to yet another advantageous embodiment of the invention, the first and second control curves G and g have a section in common corresponding to a third part of the lens, the third part being common to the first and second reflecting surfaces and light sources.

According to yet another advantageous embodiment of the invention, the first light source and the first reflecting surface provide a first signaling function, preferably a daytime running light function, the second light source and the second reflecting surface provide a second lighting or signaling function, preferably a lighting function of the high-beam type.

According to yet another advantageous embodiment of the invention, the light source is a LED.

According to yet another advantageous embodiment of the invention, the reflecting surface of the reflector is configured in such a manner that it admits a single point e for which the light rays leaving from this point and reflected by the reflector, then refracted by the lens, exit from the lens such that they are perpendicular to the circular arc A, and such that these rays or their projections intercept the circular arc A, the lighting and/or signaling beam of the module comprising these rays. The reflector and the light source are arranged in such a manner that this single point is on the light source.

According to yet another advantageous embodiment of the invention, these rays substantially form the beam, when they exit from the lens.

According to yet another advantageous embodiment of the invention, the light source is positioned on the single point e.

According to yet another advantageous embodiment of the invention, the light source is a LED comprising a semiconductor photo-emissive element, the LED being arranged in such a manner that the point e is on this photo-emissive element.

Another subject of the invention is a headlamp for an automobile vehicle, comprising a lighting and/or signaling module, noteworthy in that the module is according to the invention.

The invention offers the advantage of allowing a signaling function with a convergent or divergent beam behind a toroidal lens. This allows this function to be integrated into a module already comprising another lighting function, notably of the high-beam type, using a toroidal lens. The resulting lens may thus exhibit a generally uniform profile able to be integrated into particular styles of vehicle.

These and other objects and advantages of the invention will be apparent from the following description, the accompanying drawings and the appended claims.

### BRIEF DESCRIPTION OF THE ACCOMPANYING DRAWINGS

Other features and advantages of the present invention will be better understood with the aid of the description and of the drawings amongst which:

FIG. 1 illustrates a dual-function lighting module according to the invention;

FIG. 2 is an exploded view of the module in FIG. 1;

FIG. 3 is view in perspective of a part of the lens and of a reflector providing the daytime running light (DRL) function of the module in FIG. 1 according to the invention;

FIG. 4 is a top view of the lens and of the reflector in FIG. 3;

FIG. 5 is a cross-sectional view along the axis 5-5 of the lens in FIG. 4;

FIG. 6 is a view in perspective of the wavefront converging toward the circular arc A;

FIG. 7 is a cross-sectional view of the lens and a side view of the circular arc A, illustrating the influence of its vertical position;

FIG. 8 is a top view of the lens and of the circular arc A, illustrating the influence of its separation from the lens;

FIG. 9 is a top view of the lens and of one variant of the circular arc A;

FIG. 10 is a view in perspective of the lens and of another variant of the circular arc A, the latter being on the other side of the lens;

FIG. 11 is a view in perspective of the lens, of the reflector and of the circular arc A, illustrating the calculation of the reverse path of the light;

FIG. 12 is a view in perspective of the complete lens and of the complete reflector of the module in FIGS. 1 and 2 according to the invention;

FIG. 13 is top view of the control curve G of the daytime running light (DRL) function of the module of the invention, and also of the control curve g of the lighting function of the high-beam type of the same module; and

FIG. 14 is an alternative to the profile of the control curves G and g in FIG. 13.

### DETAILED DESCRIPTION OF THE PREFERRED EMBODIMENTS

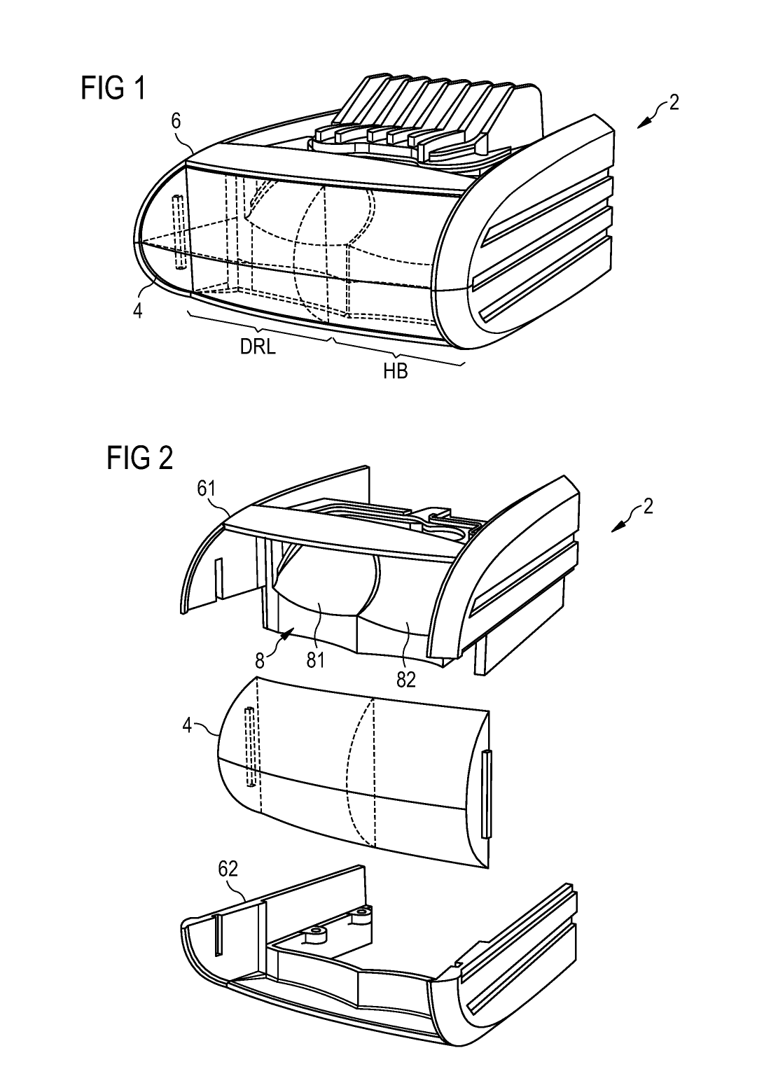

FIGS. 1 and 2 illustrate a dual-function lighting and/or signaling module 2 for an automobile vehicle, according to the invention. FIG. 1 is a view in perspective of the lighting module 2 in its assembled state, whilst FIG. 2 illustrates the same lighting module 2 in the form of an exploded view. The lighting module 2 comprises, essentially, a housing 6, a lens 4, a reflector 8 and light sources (not shown). The housing 6 is composed of two parts 61 and 62. The lighting module 2 provides two lighting functions, namely a first function of the daytime running light type commonly referred to by the acronym DRL, and a second lighting function of the high-beam type commonly denoted by the acronym HB. As can be seen in the FIGS., these two functions are provided by elements of the lighting module 2 disposed side-by-side. The reflector 8 comprises two reflecting surfaces disposed side-by-side and the lens 6 is common to these two surfaces. It has a generally toroidal shape.

The use of toroidal lens is known per se for a lighting function of the HB type, notably from the patent application published under the number FR 2 960 497 A1, which is equivalent to U.S. Patent Publication 2011/0292669, which is issued as U.S. Pat. No. 8,651,716 or again from the application published under the number EP 2565522, which is equivalent to U.S. Patent Publication 2013/0058117, which is issued as U.S. Pat. No. 8,851,724. One of the aims of the invention described here consists in integrating a signaling function such as a daytime running light function into the lighting module 2 by using a lens 6 designed to be the prolongation of the lens 6 for the HB lighting function.

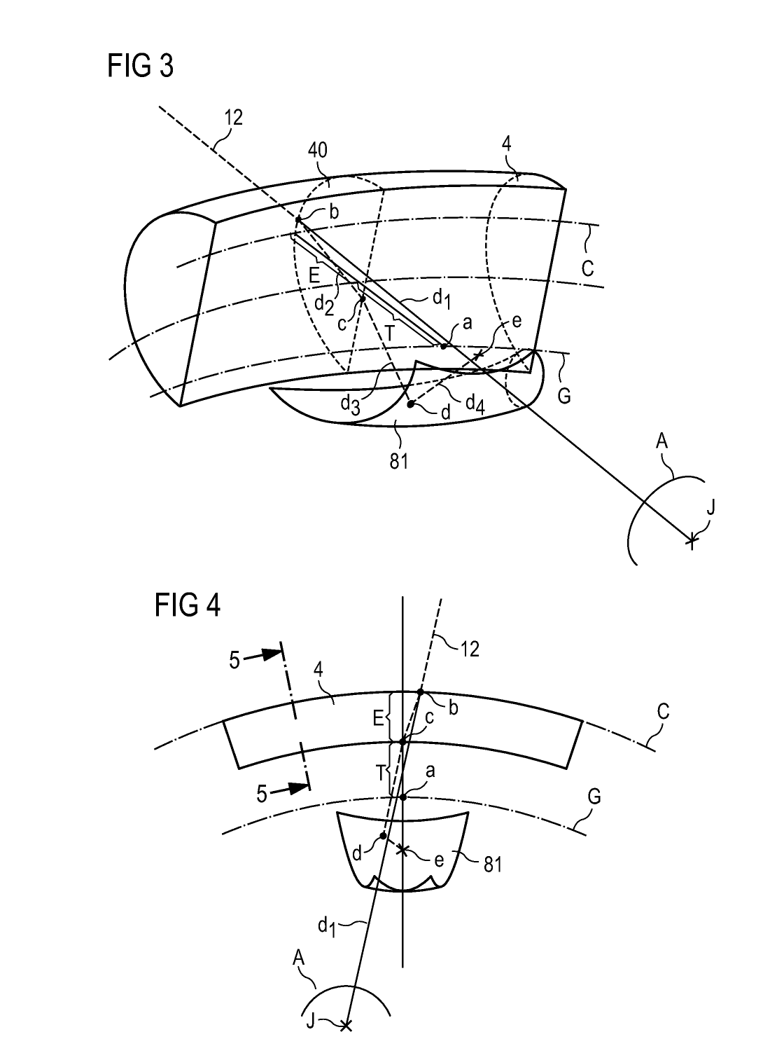

FIGS. 3 and 4 are illustrations of a part of the lens 6 and of a reflector 8 providing the daytime running light function of the lighting module 2 in FIGS. 1 and 2. FIG. 3 is a view in perspective and FIG. 4 is a top view. More particularly, these Figs. illustrate the principle of optical operation of the lighting module 2 and the principle of calculation its reflecting surface 81. The lighting module 2 essentially comprises a toroidal lens 4, a reflecting surface 81 and a point light source (or at least able to be represented by a point source) illustrated by the point e. It will however be understood that, in practice, the light source will exhibit a certain illuminating surface area; it could take the form of a high-brightness light-emitting diode (LED).

The lens 4 is constructed based on a reference plane curve C which corresponds to the external contour of the lighting module 2. A control curve G is parallel to the curve C, and consequently it is also plane. It should be noted that the control curve G preferably does not exhibit any return points or any multiple points. This condition imposes certain constraints on the curve C that those skilled in the art will immediately be able to identify. The lens 4 exhibits a cross-section in a plane perpendicular to the control curve G which is essentially constant and corresponds to that of a stigmatic plano-convex reference lens between a point situated on the side of its plane face and infinity situated on the opposite side on the side of its rounded face. The resultant focal length of a reference lens 4⁰ has a value T and its thickness in the center has a value E. The curve G is separated from the curve C by a value E+T and the lens 4 is at a distance T from the control curve G. The cross-section of the lens 4 corresponding to that of the reference lens 4⁰ defined hereinbefore is shown with a dashed line in FIG. 3. The front face of the lens 4 thus runs along the curve C. The values E and T are also illustrated in FIGS. 3 and 4.

FIG. 5, which is a cross-sectional view along the axis 5-5 of the lens 4 in FIG. 4, clearly illustrates the characteristics of the reference lens 4⁰.

With reference to FIGS. 3 and 4, the light source e and the reflecting surface 81 are disposed on the same side of the lens 4 as the control curve G. The rays exiting from the lens 4 are such that their projections intercept a circular arc A centered on J and situated in a plane parallel to that of the curves C and G. In the configuration in FIGS. 3 and 4, this circular arc A is disposed on the same side of the lens 4 as the control curve G. The rays exiting from the lens 4 and forming the illuminating beam of the lighting module 2 thus form a beam diverging from the circular arc A. The influence of the circular arc A on the form of the illuminating beam will be detailed further on with reference to FIGS. 6 to 9.

The reflecting surface 81 is configured in such a manner that the rays emitted by the light source at the point e and reflected by the surface exit from the lens 4 along directions perpendicular to the circular arc A. More precisely, the projections toward the rear of the outgoing rays are in planes perpendicular to the circular arc A and intercept the circular arc A. The reflecting surface 81 can be calculated by considering the reverse path of the light and by applying Huygens principle and Fermat's principle relating to the optical path. Indeed, according to Huygens principle, the light propagates from one point to the next, all of the points of equal light intensity perturbation being called wave surface. Each of the points of this surface reached by the light behaves as a secondary source which emits spherical wavelets into an isotropic medium. The surface, envelope of these wavelets, forms a new wave surface.

The propagation of light is more difficult or slower in media other than vacuum. The index n of the medium is defined by

n=c/v

where c and v are the speed of light in vacuum and in the medium, respectively.

The optical path is the path followed by light in vacuum during the duration of propagation in the medium:

L(AB)=∫ₜ_{_{A}}^{t}^{_{B}}cdt=∫_{A}^{B}nds=c(t_{S}−t_{A})=n·AB

where s denotes the curvilinear abscissa along the path followed in the medium between the points A and B, and AB the length of the path traveled between A and B. Fermat's principle states: between two points A and B, reached by the light, the optical path followed between the two points is invariant. This notably results in

L(AB)∫_{A}^{B}nds=∫_{B}^{A}n(−ds)=∫_{B}^{A}nds′

by considering that ds′=−ds is the curvilinear coordinate element from B to A, the following can then be written

L(AB)=L(BA)

This is the principle of reversibility of the light path: the path followed by the light in order to go from one point to another does not depend on the direction of propagation of the light.

With reference to FIG. 3, the application of the aforementioned principle to the outgoing ray 12 yields:

nd₂+d₃+d₄−d₁=K

where

d₂ is the reverse path within the lens 4 between the points b and c;

d₃ is the path between the lens 4 at the point c of entry of the ray and the point of reflection d on the reflecting surface 81;

d₄ is the path between the point of reflection d on the reflecting surface 81 and the point light source e;

d₁ is the virtual path of the ray from the circular arc A up to the exit point b of the lens 4; and

K is a constant.

The path d₁ is preceded by a negative sign because this is a virtual path in the opposite direction to that of the other. The application of the aforementioned equation to the points forming the exit surface of the lens 4 allows the surface of the reflecting surface 81 to be calculated. The deviation of the rays by reflection on the reflecting surface 81 and by refraction when passing through the lens 4 may readily be calculated by application of Snell's law.

FIG. 6 illustrates the toroidal shape of the wavefront 14 produced by rays exiting from the lens 4, these rays being perpendicular to the circular arc A and their projections intercepting the circular arc A. By considering the light source reduced to the point of convergence e, Fermat's principle of constant path between a torus and a sphere, reduced to the circular arc A and to the point e, can thus be applied.

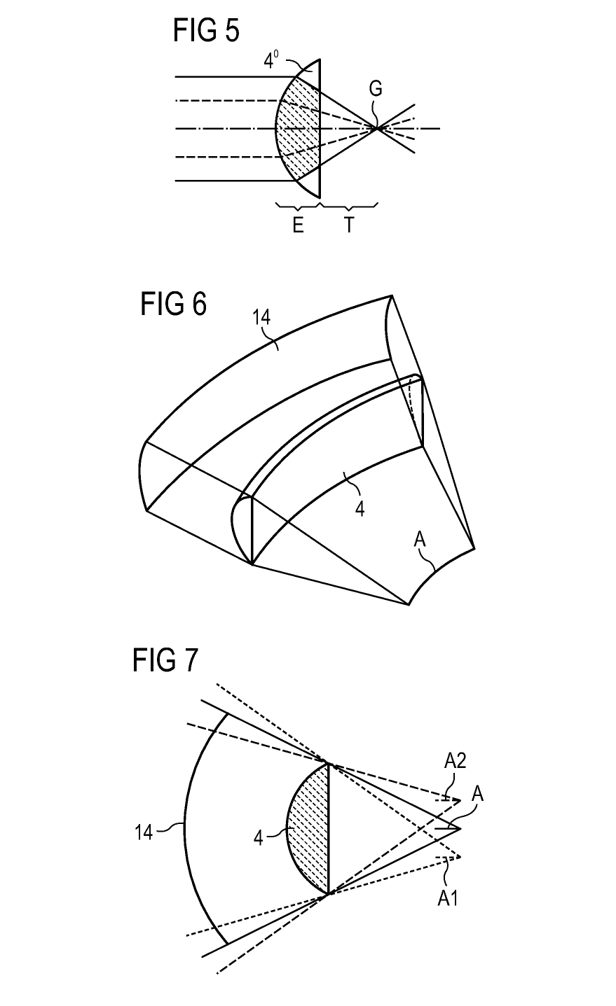

FIG. 7 is a cross-sectional view according to a longitudinal and vertical plane in FIG. 6. The circular arc A, the lens 4 and the corresponding toroidal wavefront 14 can be identified in the figure. Alternative circular arcs A1 and A2 at different heights are represented using dashed lines. They clearly illustrate the impact of the position vertically above the circular arc A, all other things being equal, on the vertical orientation of the beam: the higher the circular arc A, the more the beam is directed downward and vice versa.

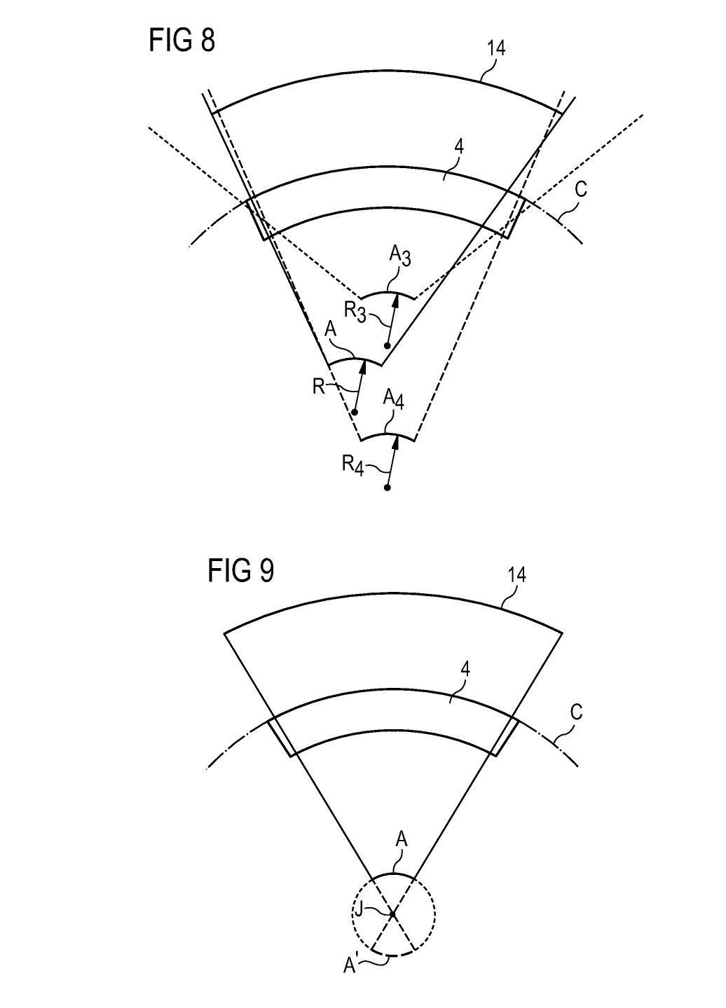

FIG. 8 is a top view of the lens 4 and of the circular arc A, illustrating the influence of its separation with respect to the lens 4 on the illuminating beam. A first alternative circular arc A3 is illustrated with a dashed line: it is nearer to the lens than the initial circular arc A and has a radius R3 less than radius R of the initial circular arc A. The radius R3 is indeed shorter in view of the condition of perpendicularity of the rays of the beam to the circular arc A. The illuminating beam corresponding, also shown using dashed lines, is more spread out horizontally than the initial beam (continuous lines). A second alternative circular arc A4 further away from the lens 4 than the initial circular arc A is also illustrated by a dashed line. Its radius R4 is greater than the radius R of the initial circular arc A. It can also be observed that the resulting illuminating beam is narrower horizontally than that resulting from the initial circular arc A. It can also be observed that any lateral displacement of the initial circular arc A modifies the orientation of the beam, and it does this in the opposite direction to the direction of displacement of the initial circular arc A.

FIG. 9, which is a top view of the circular arc A, of the lens 4 and of the toroidal wave of the beam illustrates that the circular arc A does not necessarily need to have its convexity on the side of the lens 4. Indeed, a circular arc A′ situated on the circle comprising the initial circular arc A and having its concavity toward the lens 4 is shown. The rays of the beam from the lighting module 2 can encounter the circular arc A′ and can be perpendicular to it, similarly to the initial circular arc A. It should however be noted that the circular arc A′, owing to its greater distance from the lens 4, will produce a beam less spread out vertically, with reference to FIGS. 7 and 8.

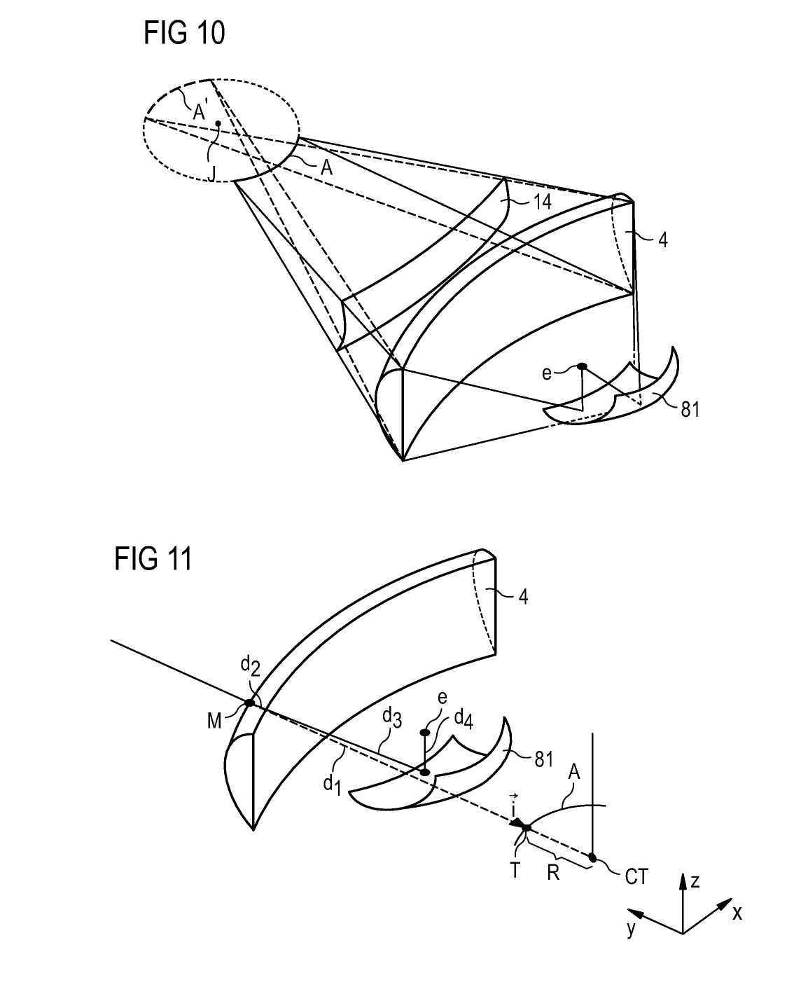

FIG. 10 is a view in perspective of the lens 4 and of another variant of the circular arc A, the latter being on the other side of the lens 4. The circular arc A is indeed on the side of the lens 4 which corresponds to the illuminating beam. It can be observed that the wavefront 14 is also toroidal, similarly to the configuration in FIG. 6 and to the explanations relating to it, with however the difference that the curvature of the wavefront 14 is reversed. When the circular arc A is disposed on this side of the lens 4, the illuminating beam is then converging.

FIG. 11 is a view in perspective of the lens 4, of the reflector 8 and of the circular arc A, illustrating the calculation of the reverse path of the light. For this purpose, it is necessary to solve the equation:

nd₂+d₃+d₄−d₁=K

described previously in relation to FIGS. 3 and 4.

In an x y z coordinate system such as shown in FIG. 11, the coordinates (iterative) of the point M, the coordinates of the center C_{T} of the circular arc A and its radius R are in principle known. The coordinates of the point T may be expressed as follows:

$$T = \frac{R}{\sqrt{{( {M}_{x} - {C}_{τ x} )}^{2} + {( {M}_{y} - {C}_{{τ}_{y}} )}^{2}}} ( \begin{matrix}{M}_{x} - {C}_{Tx} \\ {M}_{y} - {C}_{Ty} \\ 0\end{matrix} ) + ( \begin{matrix}{C}_{Tx} \\ {C}_{Ty} \\ {C}_{Tz}\end{matrix} )$$

where Mₓ and M_{y} are the coordinates along x and y of the point M; and C_{τx}, C_{τy} and C_{τz} are the coordinates along x, y and z of the point C_{T}.

The coordinate C_{Ts} corresponds to a vertical adjustment parameter in the framework of a dissymmetry such as illustrated in FIG. 7.

The virtual optical path d₁equal to MT is then known.

The normalized vector î is given by:

$$\vec{i} = - ɛ \frac{\vec{MT}}{‖ \vec{MT} ‖}$$

where ε=σ(T_{y}−M_{y}) in the case where the optical axis corresponds to the y axis: î is known. The function σ is the sign function, in other words where σ(x)=1 if x>0 and σ(x)=−1 if x<0.

The calculation of the path of the point of emergence I on the internal face of the lens 5 of the ray in the reverse return direction and of its direction î at I may subsequently be carried out by application of Snell's laws, since the ray incident at M in the reverse return direction of the light has the direction î.

Then, if P denotes the point where the ray encounters the reflector 8, \vec{IP}=d₃j and d₄Pe=∥\vec{Ie}−\vec{IP}∥=∥Ie−dₑî∥

The equation nd₂+d₁+d₄−d₁=K is than an equation with a single unknown, d₃, d₂, d₁, î and I being known (see hereinabove) together with K and e (which are design parameters).

The numerical solution of the equation in d₃ determines P (since \vec{IP}=d₃\vec{j}) and the whole set of the points P determined iteratively defines the surface of the reflector 8.

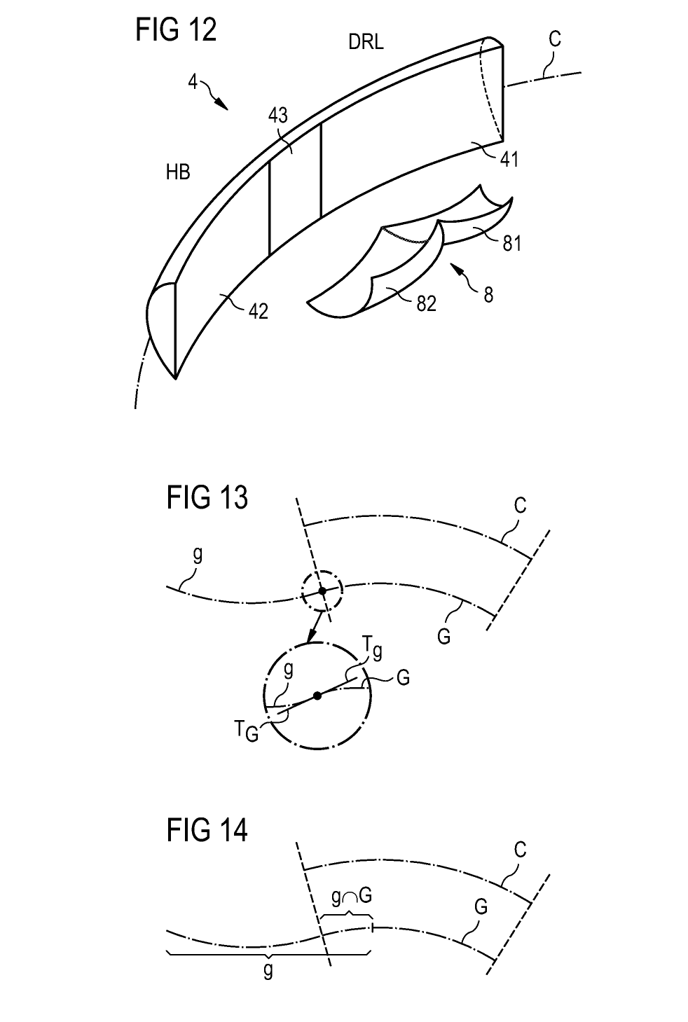

FIG. 12 is a view in perspective of the complete lens 4 and of the complete reflector 8 of the lighting module 2 in FIGS. 1 and 2 according to the invention. It can be observed that the lens 4 comprises three parts: a first part 41 corresponding to the first reflecting surface 81, a second part 42 corresponding to the second reflecting surface 82, and a third part 43 between the first and second parts 41 and 42. The third part 43 may be limited to a transition region between the other two, and may potentially be very narrow or even with a width equivalent to zero, or could form a region common to the two reflecting surfaces 81 and 82.

FIG. 13 illustrates schematically a first variant of the link between the control curve G for the daytime running light function and the control curve g for the other function such as a lighting function of the HB type. It can be observed that the curves have a single point in common, the tangents T_{G} and T_{g} of each of the two control curves G and g at this point coinciding.

FIG. 14 illustrates another variant of the junction between the control curves G and g. They exhibit a common section g∩G which corresponds to the intermediate or third part 43 in FIG. 12.

The invention has been described in relation to a daytime running light function (DRL). It should however be noted that it is applicable in the same way to other functions requiring a diffuse illumination such as for example signaling functions of the direction indicator type. The description that has just been presented is consequently also applicable to such a function which can then be integrated into a module also comprising another function such as a lighting function notably of the HB type.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A lighting and/or signaling module, notably for a vehicle, comprising:
a light source (e);
a reflector with a reflecting surface configured for reflecting light rays emitted by said light source (e);
a lens running parallel to a plane control curve G, with a cross-section at least essentially constant and corresponding to that of a stigmatic reference lens between a point situated behind said lens on said control curve G and infinity in front of said lens, said lens being configured so as to transmit said light rays reflected by said reflector so as to form a lighting and/or signaling beam;
wherein said reflecting surface of said reflector is configured in such a manner that said light rays of said lighting and/or signaling beam coming from said Sighting and/or signaling module are perpendicular to a circular arc A situated in a plane parallel to that of said control curve G, and such that said light rays or their projections intercept said circular arc A.

2. The lighting and/or signaling module as claimed in claim 1, wherein a reverse optical path of said light rays from said circular arc A up to said light source is constant according to Fermat's principle of reversibility of a light path and of invariance of said reverse optical path followed by light along a physical path.

3. The lighting and/or signaling module as claimed in claim 1 wherein said circular arc A is situated with respect to said lens of the same side as said control curve G, the projection of said light rays exiting from said lens encountering said circular arc A in planes perpendicular to said control curve G, so as to form a divergent beam.

4. The lighting and/or signaling module as claimed in claim 1, wherein said circular arc A is situated with respect to said lens on an opposite side to that of said control curve G, said light rays exiting from said lens encountering said a circular arc A in a convergent manner in planes perpendicular to said control curve G.

5. The lighting and/or signaling module as claimed in claim 1, wherein said reference lens is of the plano-convex type, said lens of said lighting and/or signaling module exhibiting a convex exit face.

6. The lighting and/or signaling module as claimed in claim 1, wherein said lens comprises an exit face extending following a plane curve C parallel to said control curve G.

7. The lighting and/or signaling module as claimed in claim 1, wherein said light source is a first light source and said reflecting surface is a first reflecting surface, said lighting and/or signaling module comprising a second light source and a second reflecting surface configured for reflecting said light rays emitted by said second light source, disposed laterally to said first light source and to said first reflecting surface with respect to a main direction of illumination, said lens extending in front of and cooperating with said second light source and said second reflecting surface.

8. The lighting and/or signaling module as claimed in claim 7, wherein said second reflecting surface is configured in such a manner that said light rays of an illuminating beam and/or of signaling coming from said second reflective surface are parallel to a given direction corresponding to a main direction of illumination of said lighting and/or signaling module.

9. The lighting and/or signaling module as claimed in claim 7, wherein said lens comprises a first part cooperating at least for the majority with said light rays coming from said first light source and reflected by said first reflecting surface, said control curve G of said first part being a first control curve, and a second part cooperating at least for the majority with said light rays coming from said second light source and reflected by second said reflecting surface, said second part extending following a second plane control curve g, said second control curve g having at least one point in common with said control curve G, the tangents to said first and second control curves G and g being coincident at said at least one point.

10. The lighting and/or signaling module as claimed in claim 9, wherein said first and second control curves G and g have a section in common corresponding to a third part of said lens, said third part being common to said first reflecting surface and said second reflecting surface and said first and second light sources.

11. The lighting and/or signaling module as claimed in claim 7, wherein said first light source and said first reflecting surface provide a first signaling function, preferably a daytime running light function or a direction indicator function, said second light source and said second reflecting surface provide a second lighting or signaling function, preferably a lighting function of the high-beam type.

12. The lighting and/or signaling module as claimed in claim 1, wherein said light source is a LED.

13. The lighting and/or signaling module as claimed in claim 1, wherein said reflecting surface of said reflector is configured in such a manner that it admits a single point for which said light rays leaving from this point and reflected by said reflector, then refracted by said lens, exit from said lens such that they are perpendicular to said circular arc A, and such that said light rays or their projections intercept said circular arc A, said lighting or signaling beam of said lighting and/or signaling module comprising said light rays.

14. The lighting and/or signaling module as claimed in claim 13, wherein said light rays substantially form said lighting or signaling beam, when they exit from said lens.

15. The lighting and/or signaling module as claimed in claim 13, wherein said light source is positioned on said single point.

16. The lighting and/or signaling module as claimed in claim 15, wherein said light source is a LED comprising a semiconductor photo-emissive element, said LED being arranged in such a manner that said single point is on photo-emissive element.

17. A headlamp for automobile vehicle, comprising a lighting and/or signaling module, wherein said lighting, and/or signaling module is according to claim 1.

18. The lighting and/or signaling module as claimed in claim 2, wherein said circular arc A is situated with respect to said lens of the same side as said control curve G, the projection of said light rays exiting from said lens encountering said circular arc A in planes perpendicular to said control curve G, so as to form a divergent beam.

19. The lighting and/or signaling module as claimed in claim 2, wherein said circular arc A is situated with respect to said lens on an opposite side to that of said control curve G, said light rays exiting from said lens encountering said circular arc A in a convergent manner in planes perpendicular to said control curve G.

20. The lighting and/or signaling module as claimed in claim 14, wherein said light source is positioned on said single point.
